(19) United States
(12) Patent Application Publication
(10) Pub. No.: US 2026/0103091 A1
(43) Pub. Date: Apr. 16, 2026

(54) SYSTEMS AND METHODS FOR APPLYING FLUCTUATING COMPRESSION FORCE TO BATTERY ARRAY

(71) Applicant: Ford Global Technologies, LLC, Dearborn, MI (US)

(72) Inventors: Kent Snyder, Dearborn, MI (US); Minghong Liu, Canton, MI (US); Wenhui Zhu, Northville, MI (US)

(21) Appl. No.: 18/913,231

(22) Filed: Oct. 11, 2024

(51) Int. Cl. B60L 50/64; B60L 53/10; B60L 53/62

(52) U.S. Cl. CPC B60L 50/64; B60L 53/11; B60L 53/62

(57) ABSTRACT

A battery charging system may include a battery array. A battery charging system may include a compression device configured to apply a compression force to the battery array during a charging event. A battery charging system may include a control module programmed to control the compression device such that the compression force fluctuates between a lower threshold and an upper threshold independent of a charging rate during the charging event.

### TECHNICAL FIELD

This disclosure relates to battery charging systems and methods for applying a fluctuating compression force to battery cells during charging events.

### BACKGROUND

A traction battery pack typically powers an electric machine and other electrical loads of an electrified vehicle. The traction battery pack includes a plurality of battery cells that must be periodically recharged to replenish the energy necessary to power these loads.

### SUMMARY

In some aspects, the techniques described herein relate to a battery charging system, including: a battery array; a compression device configured to apply a compression force to the battery array during a charging event; and a control module programmed to control the compression device such that the compression force fluctuates between a lower threshold and an upper threshold independent of a charging rate during the charging event.

In some aspects, the techniques described herein relate to a battery charging system, wherein the charging event includes DC fast charging.

In some aspects, the techniques described herein relate to a battery charging system, wherein the control module is programmed to control the compression device such that the compression force fluctuates between the lower threshold and the upper threshold while the charging rate varies during the charging event.

In some aspects, the techniques described herein relate to a battery charging system, wherein the lower threshold and the upper threshold are pre-set thresholds and do not change throughout an entirety of a duration of the charging event.

In some aspects, the techniques described herein relate to a battery charging system, wherein the control module is programmed to control the compression device such that the compression force fluctuates between the lower threshold and the upper threshold according to a predefined pattern during the charging event.

In some aspects, the techniques described herein relate to a battery charging system, wherein the predefined pattern is such that the control module is programmed to control the compression device such that the compression force oscillates between the lower threshold and the upper threshold.

In some aspects, the techniques described herein relate to a battery charging system, wherein the predefined pattern is such that the control module is programmed to control the compression device such that the compression force oscillates linearly between the lower threshold and the upper threshold.

In some aspects, the techniques described herein relate to a battery charging system, wherein the predefined pattern is such that wherein the control module is programmed to control the compression device such that the compression force oscillates substantially as a sine wave between the lower threshold and the upper threshold.

In some aspects, the techniques described herein relate to a battery charging system, wherein the predefined pattern includes controlling the compression device such that the compression force substantially alternates between the lower threshold and the upper threshold.

In some aspects, the techniques described herein relate to a battery charging system, wherein the predefined pattern includes controlling the compression device such that the compression force periodically, and at predefined intervals, substantially alternates between the lower threshold and the upper threshold.

In some aspects, the techniques described herein relate to a battery charging system, wherein the compression device includes an air bladder.

In some aspects, the techniques described herein relate to a battery charging system, wherein the compression device includes an air cylinder or a hydraulic cylinder.

In some aspects, the techniques described herein relate to a battery charging system, wherein the compression device includes a motor actuated threaded shaft rod.

In some aspects, the techniques described herein relate to a battery charging system, wherein the compression device includes a shape memory alloy structure.

In some aspects, the techniques described herein relate to a battery charging system, including a sensor system operably coupled to the control module and configured to monitor a charge rate during the charging event.

In some aspects, the techniques described herein relate to a battery charging system, wherein the control module is a component of an electrified vehicle that includes the battery charging system.

In some aspects, the techniques described herein relate to a battery charging system, wherein the control module is a component of an electric vehicle supply equipment (EVSE) system.

In some aspects, the techniques described herein relate to a method, including: fluctuating a compression force applied to a battery array of a traction battery pack during a charging event, wherein the compression force fluctuates between a lower threshold and an upper threshold independent of a charging rate during the charging event.

In some aspects, the techniques described herein relate to a method, wherein the compression force fluctuates between the lower threshold and the upper threshold according to a predefined pattern during the charging event.

In some aspects, the techniques described herein relate to a method, wherein the predefined pattern is such that the compression force either (i) substantially oscillates between the lower threshold and the upper threshold or (ii) substantially alternates between the lower threshold and the upper threshold.

### BRIEF DESCRIPTION OF THE DRAWINGS

FIG. 1 illustrates an electrified vehicle operably connected to an electric vehicle supply equipment (EVSE) system.

FIG. 2 schematically illustrates an exemplary battery charging system.

FIG. 3A is a graphical representation of a first example pattern representative of a compression force relative to time.

FIG. 3B is a graphical representation of a second example pattern representative of a compression force relative to time.

FIG. 3C is a graphical representation of a third example pattern representative of a compression force relative to time.

FIG. 4 schematically illustrates another exemplary battery charging system.

FIG. 5 schematically illustrates a compression device of the battery charging system of FIG. 4.

FIG. 6 schematically illustrates another exemplary battery charging system.

FIG. 7 schematically illustrates another exemplary battery charging system.

FIG. 8 schematically illustrates another exemplary battery charging system.

FIG. 9 schematically illustrates another exemplary battery charging system.

FIG. 10 schematically illustrates another exemplary battery charging system.

FIG. 11 schematically illustrates another exemplary battery charging system.

FIG. 12 schematically illustrates another exemplary battery charging system.

FIG. 13 schematically illustrates another exemplary battery charging system.

FIG. 14 schematically illustrates another exemplary battery charging system.

### DETAILED DESCRIPTION

This disclosure relates to battery charging systems and methods for applying a fluctuating compression force to battery cells during charging events. An exemplary battery charging system may include a battery array, a compression device configured to apply a compression force to the battery array during a charging event, and a control module. The control module may be programmed to control the compression device such that the compression force fluctuates between a lower threshold and an upper threshold independent of a charging rate during the charging event. Doing so may increase battery performance, among other potential benefits, which will be appreciated from the following description.

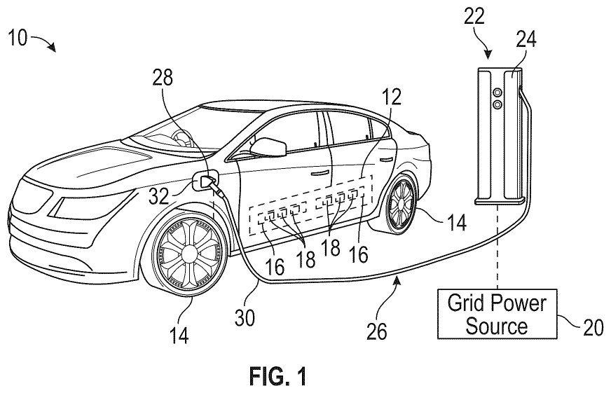

FIG. 1 illustrates an exemplary electrified vehicle 10 that includes a traction battery pack 12. The electrified vehicle 10 may include any electrified powertrain capable of applying a torque from an electric machine for providing motive power for driving drive wheels 14 (or other traction devices) of the electrified vehicle 10. In an embodiment, the electrified vehicle 10 is a plug-in hybrid electric vehicle (PHEV). In another embodiment, the electrified vehicle is a battery electric vehicle (BEV). Therefore, the powertrain of the electrified vehicle 10 may electrically propel the drive wheels 14 either with or without the assistance of an internal combustion engine.

The electrified vehicle 10 of FIG. 1 is schematically illustrated as a car. However, the teachings of this disclosure may be applicable to any type of vehicle, including but not limited to, cars, trucks, vans, sport utility vehicles (SUVs), airplanes, boats, buses, drones, etc.

Although shown schematically, the traction battery pack 12 may be a high voltage traction battery pack that includes a plurality of battery arrays 16 (e.g., battery assemblies or groupings of battery cells 18) capable of outputting electrical power to one or more electric machines (e.g., electric motors) of the electrified vehicle 10. In an embodiment, the battery cells 18 are lithium-ion battery cells. However, other types of energy storage devices and/or output devices can also be used to electrically power the electrified vehicle 10.

The battery cells 18 of the traction battery pack 12 may periodically require charging for replenishing their energy levels. The electrified vehicle 10 may therefore interface with a grid power source 20 (e.g., AC power, solar power, wind power, or combinations thereof) through an electric vehicle supply equipment (EVSE) system 22 in order to transfer energy from the grid power source 20 to the electrified vehicle 10 for charging the traction battery pack 12.

The EVSE system 22 may include an EVSE housing 24 and a charge cord assembly 26. The EVSE housing 24 may be configured as a wall box, a charging station stanchion, etc. The specific configuration of the EVSE housing 24 is not intended to limit this disclosure. The EVSE housing 24 may include the necessary equipment (e.g., relays, human machine interfaces, etc.) for coordinating the transfer of energy between the electrified vehicle 10 and the grid power source 20.

The charge cord assembly 26 may include a charge coupler 28 and a cable 30. The cable 30 may be connected at one end to the charge coupler 28 and at an opposite end to the EVSE housing 24. The charge coupler 28 may be coupled (e.g., plugged-in) to a charge port assembly 32 (sometimes referred to as a vehicle inlet assembly) of the electrified vehicle 10 in order to transfer energy from the grid power source 20 to the electrified vehicle 10.

In an embodiment, the charge coupler 28 is configured to plug into an SAE J1772 type charge port assembly 32. However, other charge coupler/charge port configurations are further contemplated within the scope of this disclosure. The specific configurations of the charge coupler 28 and the charge port assembly 32 are therefore not intended to limit this disclosure.

The EVSE system 22 and the electrified vehicle 10 may be configured to provide any level of charging (e.g., Level 1 AC charging, Level 2 AC charging, DC fast charging, etc.). In general, Level 1 charging refers to charging events in which power levels of less than about 2.4 kW are delivered for charging the battery cells 18 of the traction battery pack 12, and Level 2 charging refers to charging events in which power levels of between about 3 kW and about 20 kW are delivered for charging the battery cells 18 of the traction battery pack 12. Both Level 1 and Level 2 charging are typically delivered using an onboard power conversion module that is adapted to convert AC inputs to DC outputs that can be accepted by the traction battery pack 12. DC fast charging refers to charging events in which power levels of about 50 kW or more are delivered for rapidly charging the battery cells 18 of the traction battery pack 12. In this disclosure, the term “about” means that the expressed quantities or ranges need not be exact but may be approximated and/or larger or smaller, reflecting acceptable tolerances, conversion factors, measurement error, etc.

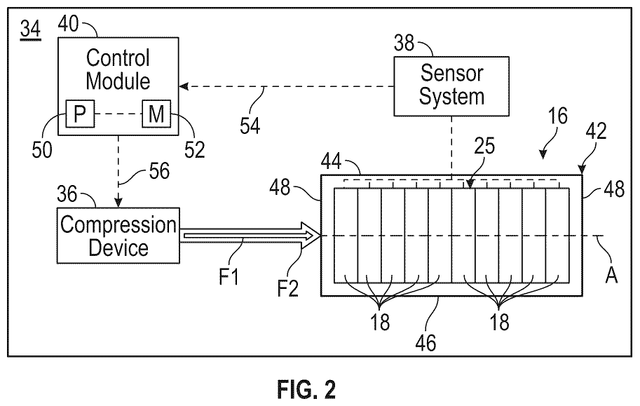

FIG. 2 is a highly schematic depiction of a battery charging system 34 that could be implemented on the electrified vehicle 10 or any other electrified vehicle. The battery charging system 34 may be configured to vary the compression force applied to a battery array 16 of a traction battery pack 12 during charging events in order to positively influence the cycle life of the battery cells 18 of the battery array 16.

A single battery array 16 is shown in FIG. 2 for simplicity. However, it should be recognized that the battery charging system 34 could be configured to vary the compression force applied to one or more battery arrays 16.

The battery charging system 34 may include one or more battery arrays 16, a compression device 36, a sensor system 38, and a control module 40. Each battery array 16 may include a plurality of battery cells 18. The battery array 16 could employ any number of battery cells 18. The battery cells 18 may be stacked together along a longitudinal axis A to establish a cell stack 25 of the battery array 16.

In an embodiment, the battery cells 18 are lithium-ion cells. However, other cell chemistries (nickel-metal hydride, solid state batteries, lithium-metal batteries, etc.) could alternatively be utilized within the scope of this disclosure.

In another embodiment, the battery cells 18 are prismatic or pouch battery cells. However, other cell geometries could alternatively be utilized within the scope of this disclosure.

A support structure 42 of the battery array 16 may substantially surround the cell stack 25. In an embodiment, the support structure 42 completely encloses the cell stack 25. In some implementations, the support structure 42 may include a top plate 44, a bottom plate 46, a pair of end plates 48, and a pair of side plates (not shown in the schematic depiction of FIG. 2).

The compression device 36 may be configured to selectively apply a compression force of an optimal value to the battery array 16 during charging events. In an embodiment, the compression force may be applied along the direction of the longitudinal axis A of the cell stack 25 of the battery array 16. However, the compression force could alternatively or additionally be applied in a direction that is transverse to the longitudinal axis A. In another embodiment, the compression force is applied perpendicular to planar surfaces of electrode layers within each battery cell 18 of the cell stack 25. In another embodiment, the compression force is applied both along the longitudinal axis A and in a direction that is transverse to the longitudinal axis A, with the transverse compression force being lower than the longitudinal compression force. In yet another embodiment, the compression device 36 may interface with portions of the support structure 42 for applying the compression force.

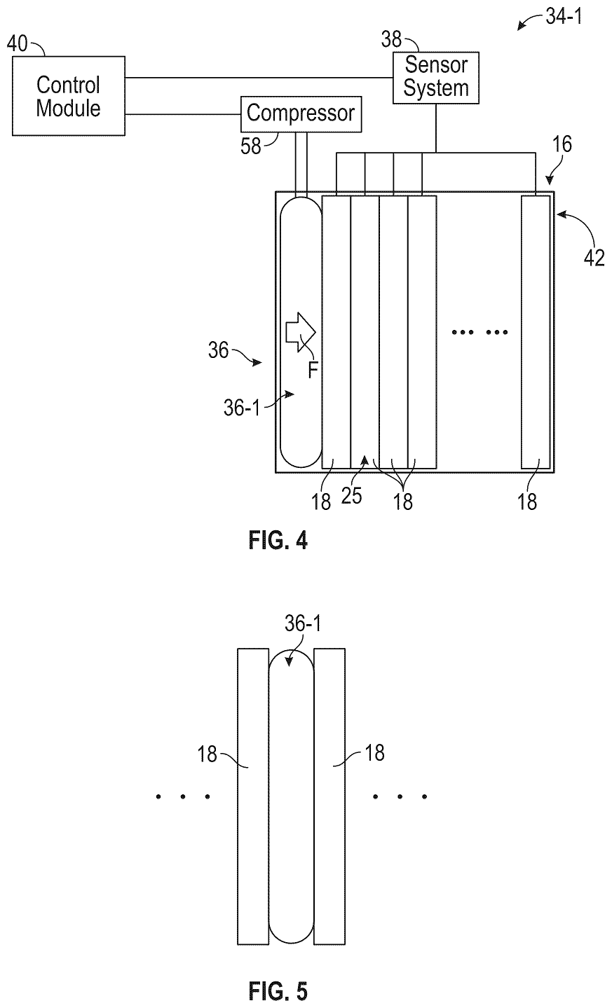

The compression device 36 may be any device capable of mechanically applying the compression force during charging events. Examples of suitable compression devices 36 include but are not limited to air bladders, air cylinders, hydraulic cylinders, motor actuated threaded shaft rods, shape memory alloy structures, etc. (see, e.g., specification implementations of FIGS. 4-14).

The sensor system 38 may be configured to sense various operating conditions associated with the battery array 16, and in particular, parameters associated with the battery cells 18. In an embodiment, the sensor system 38 may include one or more sensors that are operably linked to each battery cell 18 of the battery array 16 and that are configured to sense one or more operating conditions associated with each respective battery cell 18. The sensor system 38 may be part of a battery management system (BMS) capable of monitoring each individual battery cell 18 of the battery array 16.

The control module 40 may be operably connected to both the compression device 36 and the sensor system 38. The control module 40 may include both hardware and software and could be part of either the electrified vehicle 10, the EVSE system 22, or both. Thus, although shown as a single controller, the control module 40 could include multiple control units that can communicate with one another for controlling the battery charging system 34. In an embodiment, the control module 40 is programmed with executable instructions for interfacing with and commanding operations of the various subcomponents of the battery charging system 34.

The control module 40 may include a processor 50 and non-transitory memory 52 for executing the various control strategies and modes associated with the battery charging system 34. The processor 50 can be a custom made or commercially available processor, a central processing unit (CPU), or generally any device for executing software instructions. The memory 52 may include any one or combination of volatile memory elements and/or nonvolatile memory elements.

The processor 50 may be operably coupled to the memory 52 and may be configured to execute one or more programs stored in the memory 52 of the control module 40 based on various inputs received from other devices, such as inputs from the sensor system 38. For example, the sensor system 38 may be designed to periodically communicate a signal 54 to the control module 40 during charging events. The signal 54 may include information associated with the battery array 16, such as whether the battery cells 18 are currently being charged (i.e., whether a charging event is occurring), or the current compressive force applied to the battery array 16, as examples. In response to receiving the signal 54, the control module 40 may command (e.g., by communicating a control signal 56) activation of the compression device 36. The compression device 36 may then apply the appropriate compression force to the cell stack 25 of the battery array 16.

In this disclosure, the control module 40 is programmed to fluctuate the compression force applied to the cell stack 25 of the battery array 16 throughout a charging event. In particular, in this disclosure, the control module 40 is configure to to control the compression device 36 such that the compression force fluctuates between a lower threshold (i.e., a lower compression force threshold) F1 and an upper threshold (i.e., an upper compression force threshold) F2 independent of a charging rate during the charging event. In a more specific implementation, despite changes in the charging rate, namely the charging rate of the battery array 16 (i.e., the C-rate), that may occur during a charging event, such as a DC fast charging event, the control module 40 is configured to control the compression device 36 such that the compression force fluctuates between a lower threshold F1 and an upper threshold F2. In an even more specific implementation, despite changes in the charging rate of the battery array 16, the control module 40 is configure to control the compression device 36 such that the compression force fluctuates between a lower threshold F1 and an upper threshold F2 throughout an entirety of a duration of a charging event.

In an example, the lower threshold F1 and the upper threshold F2 are predefined values stored in the memory of the control module 40. Further, the lower threshold F1 and the upper threshold F2 are pre-set values that do not change during a charging event.

In an aspect of this disclosure, the control module 40 is programmed to control the compression device 36 such that the compression force applied to the cell stack 18 fluctuates between the lower threshold F1 and the upper threshold F2 according to a predefined pattern during the charging event, again, regardless of changes in charging rate. In this aspect of the disclosure, the pattern does not change with changes in charging rate. Further, the lower and upper thresholds F1, F2 also do not change with changes in charging rate. Rather, the control module 40 is programmed to control the compression device 36 according to the pattern from the beginning of a charging event to an end of a charging event, regardless of any changes in conditions such as charging rate that may occur during the charging event.

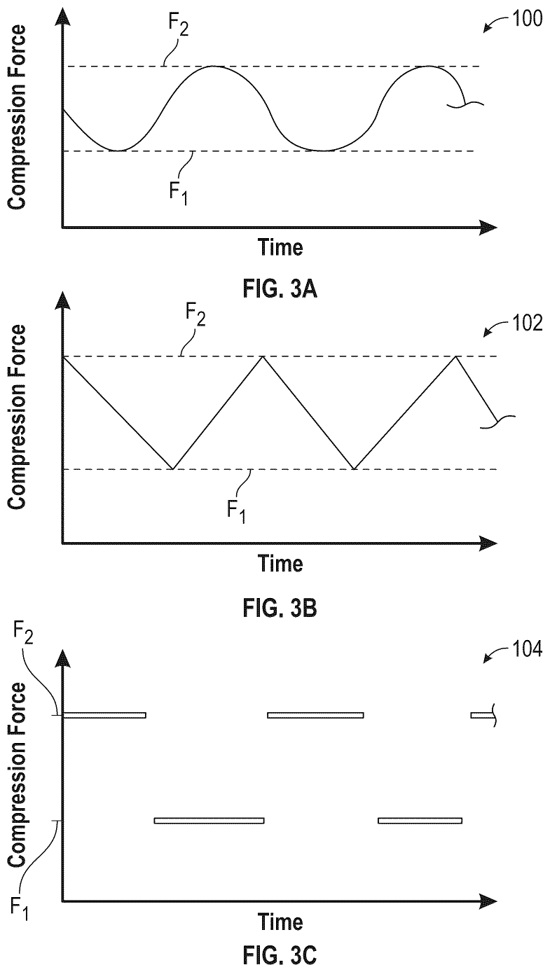

In one particular aspect of this disclosure, the control module 40 is programmed to control the compression device 36 according to an oscillating pattern. One example pattern 100 is shown in FIG. 3A. In the example of FIG. 3A, the pattern 100 oscillates substantially as a sine wave between the lower threshold F1 and the upper threshold F2. Another example oscillating pattern is shown in FIG. 3B. In FIG. 3B, the pattern 102 oscillates linearly between the lower threshold F1 and the upper threshold F2. While patterns 100, 102 are symmetrical, the control module 40 could follow an asymmetric oscillating pattern. Such asymmetric oscillating patterns may take less time to increase the compression force from the lower threshold F1 to the upper threshold F2 than a time it takes to reduce the compression force from the upper threshold F2 to the lower threshold F1, or vice versa.

In another aspect of this disclosure, the control module 40 is programmed to control the compression device 36 according to an alternating pattern. One example of such a pattern is shown in FIG. 3C, in which pattern 104 alternates between the lower threshold F1 and the upper threshold F2. Pattern 104 alternates between the lower threshold F1 and the upper threshold F2 periodically, at predefined intervals. While pattern 104 is symmetrical, the control module 40 could follow an asymmetric alternating pattern. For instance, the pattern could apply the lower threshold force F1 for a longer time than the upper threshold force F2, or vice versa. Further, it should be understood that in practice the pattern 104 may not perfectly alternate between lower threshold F1 and upper threshold F2, but may be deemed to substantially alternate between the lower threshold F1 and upper threshold F2 and exhibit a substantially vertical slope in locations where the pattern 104 transitions between the lower threshold F1 and upper threshold F2.

FIGS. 4-14 schematically illustrate various potential implementations for providing a battery charging system capable of altering the compression force applied to a battery array 16 during charging events in order to influence the cycle life of the battery cells 18 of the battery array 16. Other implementations than those depicted in FIGS. 4-14 could be recognized by persons of ordinary skill in the art and are therefore contemplated within the scope of this disclosure.

FIG. 4 illustrates a battery charging system 34-1 in which the compression device 36 includes an air bladder 36-1 arranged to apply compression forces to the battery array 16. In an embodiment, the air bladder 36-1 is arranged between a portion of the support structure 42 and the cell stack 25. In another embodiment, the air bladder 36-1 is arranged between adjacent battery cells 18 of the cell stack 25 (see FIG. 5).

In use, the sensor system 38 may communicate parameters to the control module 40 during charging events. The control module 40 may command a compressor 58 to either inflate the air bladder 36-1 to increase a compression force F or deflate the air bladder 36-1 to reduce the compression force F.

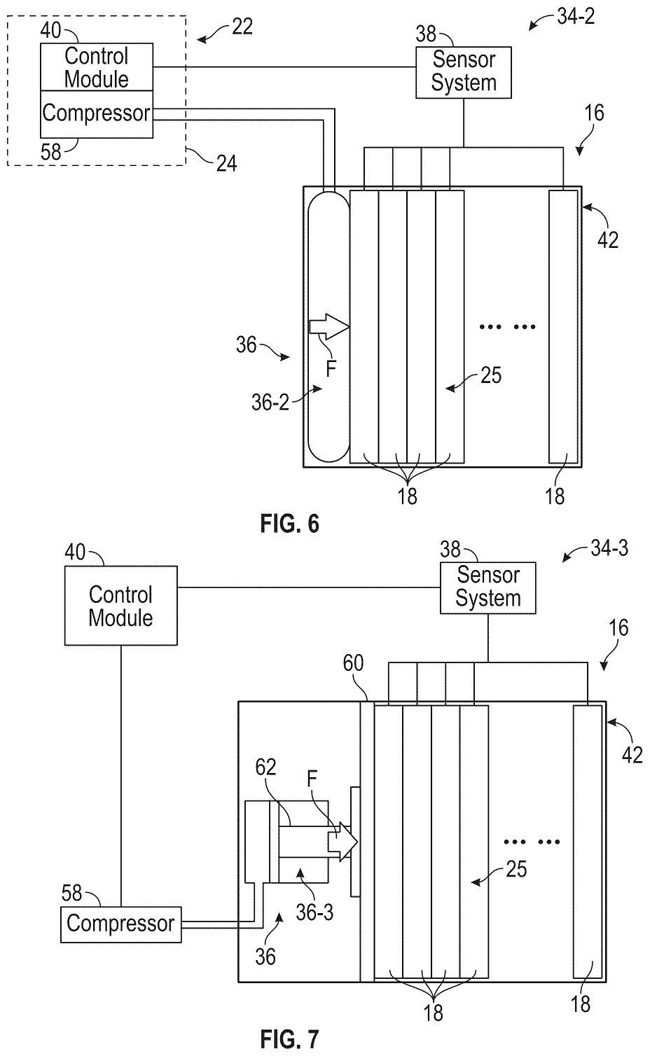

FIG. 6 illustrates another exemplary battery charging system 34-2. The battery charging system 34-2 is similar to the battery charging system 34-1 of FIG. 4 and may include an air bladder 36-2 as part of the compression device 36. However, in the implementation of FIG. 4, the control module 40 and the compressor 58 are components of the electrified vehicle 10, whereas in the implementation of FIG. 6, the control module 40 and the compressor 58 may be components housed within the EVSE housing 24 of the EVSE system 22. In such an implementation, compressed air from the compressor 58 may be transferred from the EVSE housing 24 to the air bladder 36-2 (e.g., via the charge port assembly 32 and the charge cord assembly 26).

FIG. 7 illustrates a battery charging system 34-3 in which the compression device 36 includes an air cylinder 36-3 arranged to apply compression forces to the battery array 16. In an embodiment, the air cylinder 36-3 is arranged between a portion of the support structure 42 and the cell stack 25 and may apply the compression forces directly to one of the battery cells 18 or to a flat plate 60 located between the air cylinder 36-3 and the cell stack 25.

In use, the sensor system 38 may communicate parameters to the control module 40 during charging events. The control module 40 may command a compressor 58 to either extend a piston 62 of the air cylinder 36-3 to increase a compression force F or retract the piston 62 of the air cylinder 36-3 to reduce the compression force F.

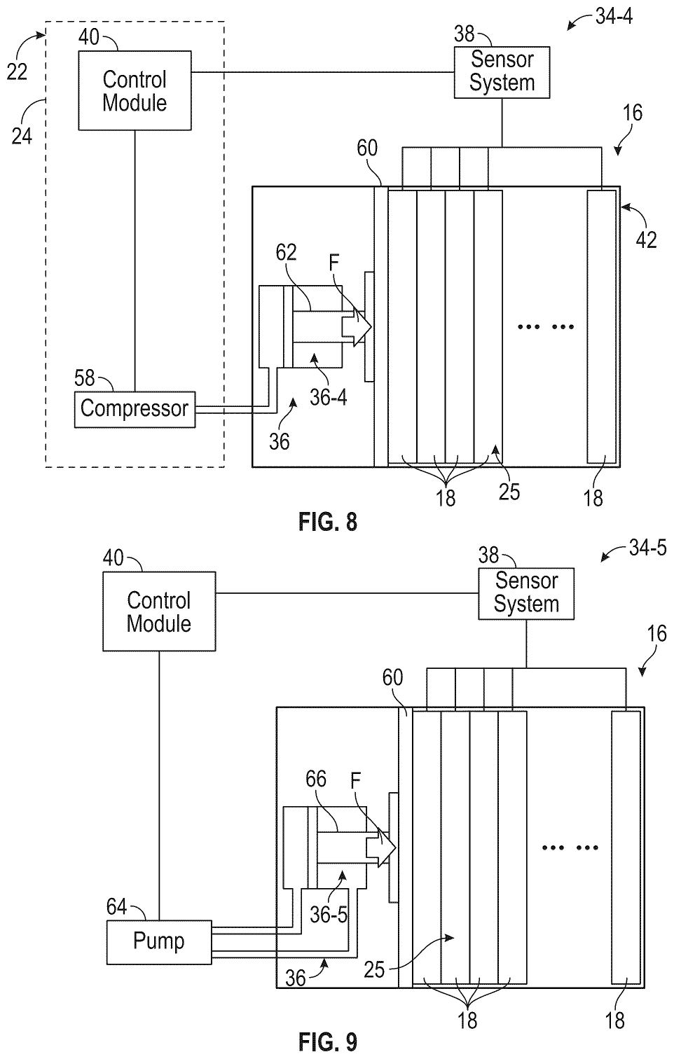

FIG. 8 illustrates another exemplary battery charging system 34-4. The battery charging system 34-4 is similar to the battery charging system 34-3 of FIG. 7 and may include an air cylinder 36-4 as part of the compression device 36. However, in the implementation of FIG. 7, the control module 40 and the compressor 58 are components of the electrified vehicle 10, whereas in the implementation of FIG. 8, the control module 40 and the compressor 58 may be components housed within the EVSE housing 24 of the EVSE system 22. In such an implementation, compressed air from the compressor 58 may be transferred from the EVSE housing 24 to the air cylinder 36-4 (e.g., via the charge port assembly 32 and the charge cord assembly 26).

FIG. 9 illustrates a battery charging system 34-5 in which the compression device 36 includes a hydraulic cylinder 36-5 arranged to apply compression forces to the battery array 16. In an embodiment, the hydraulic cylinder 36-5 is arranged between a portion of the support structure 42 and the cell stack 25 and may apply the compression forces directly to one of the battery cells 18 or to a flat plate 60 located between the hydraulic cylinder 36-5 and the cell stack 25.

In use, the sensor system 38 may communicate parameters to the control module 40 during charging events. The control module 40 may command a pump 64 to supply a fluid to the hydraulic cylinder 36-5 to either extend a piston 66 of the hydraulic cylinder 36-5 to increase a compression force F or retract the piston 66 of the hydraulic cylinder 36-5 to reduce the compression force F.

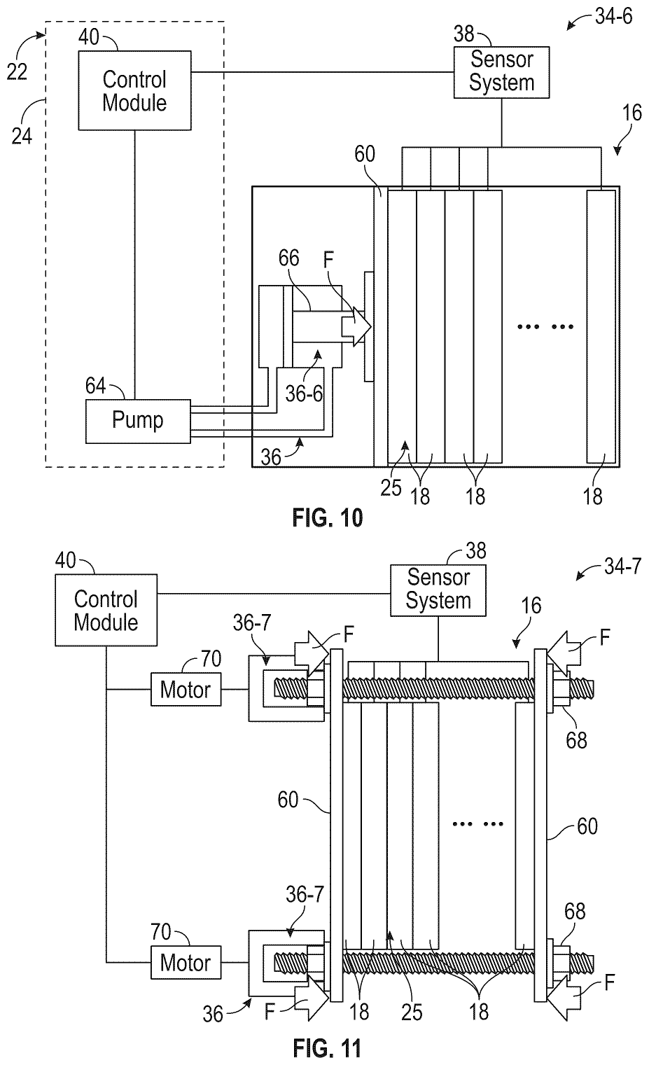

FIG. 10 illustrates another exemplary battery charging system 34-6. The battery charging system 34-6 is similar to the battery charging system 34-5 of FIG. 9 and may include a hydraulic cylinder 36-6 as part of the compression device 36. However, in the implementation of FIG. 9, the control module 40 and the pump 64 are components of the electrified vehicle 10, whereas in the implementation of FIG. 10, the control module 40 and the pump 64 may be components housed within the EVSE housing 24 of the EVSE system 22. In such an implementation, fluid from the pump 64 may be transferred from the EVSE housing 24 to the hydraulic cylinder 36-6 (e.g., via the charge port assembly 32 and the charge cord assembly 26).

FIG. 11 illustrates a battery charging system 34-7 in which the compression device 36 includes one or more screw shaft rods 36-7 arranged to apply compression forces to the battery array 16. Each screw shaft rod 36-7 may be secured to the battery array 16 via a nut 68. The screw shaft rods 36-7 may apply the compression forces to flat plates 60 that flank the battery cells 18 of the cell stack 25.

In use, the sensor system 38 may communicate parameters to the control module 40 during charging events. The control module 40 may command a motor 70 associated with each screw shaft rod 36-7 to rotate the screw shaft rod 36-7 in a first direction to increase a compression force F, or to rotate the screw shaft rod 36-7 in a second direction to reduce the compression force F.

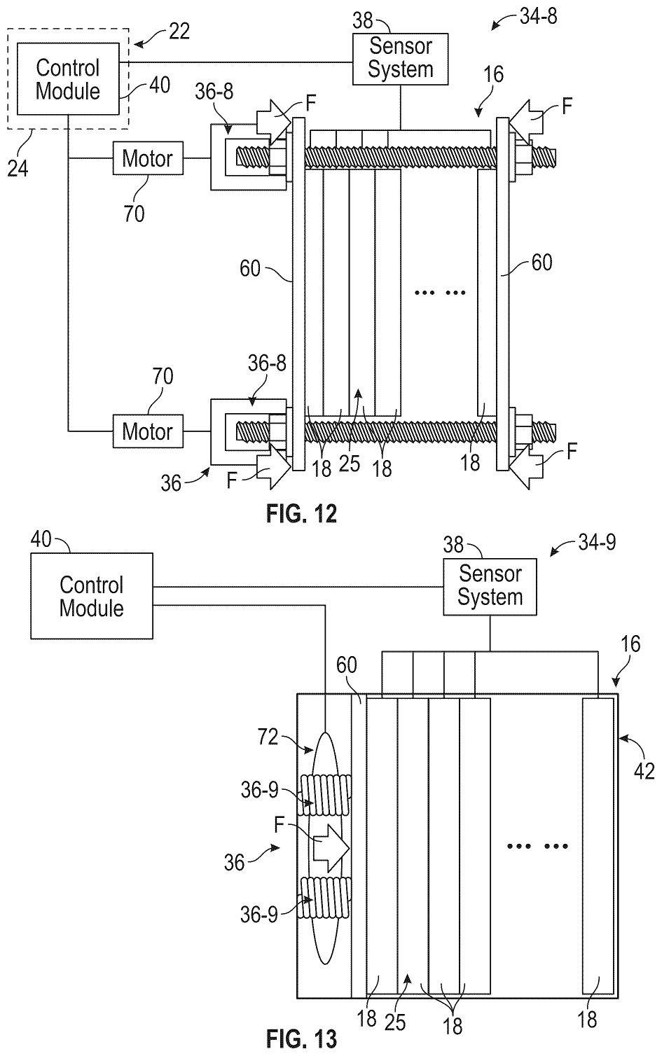

FIG. 12 illustrates another exemplary battery charging system 34-8. The battery charging system 34-8 is similar to the battery charging system 34-7 of FIG. 11 and may include one or more screw shaft rods 36-7 as part of the compression device 36. However, in the implementation of FIG. 11, the control module 40 is a component of the electrified vehicle 10, whereas in the implementation of FIG. 12, the control module 40 may be a component housed within the EVSE housing 24 of the EVSE system 22.

FIG. 13 illustrates a battery charging system 34-9 in which the compression device 36 includes one or more shape memory alloy structures 36-9 arranged to apply compression forces to the battery array 16. In an embodiment, the shape memory alloy structures 36-9 are spring-like coiled structures. However, other implementations are also possible.

Each shape memory alloy structure 36-9 may be secured between a portion of the support structure 42 and the cell stack 25 and may apply the compression forces directly to one of the battery cells 18 or to a flat plate 60 located between the shape memory alloy structures 36-9 and the cell stack 25.

In use, the sensor system 38 may communicate parameters to the control module 40 during charging events. The control module 40 may command a heating element 72 to heat the shape memory alloy structures 36-9, thereby causing them to change shape (e.g., lengthen). Lengthening the shape memory alloy structures 36-9 may increase a compression force F, and shortening the shape memory alloy structures 36-9 (e.g., by reducing or eliminating the heat) may reduce the compression force F. The control module 40 may be configured to automatically vary the compression force F as the charge rate changes.

The heating element 72 may be housed within or adjacent to the battery array 16. However, other implementations could also be possible.

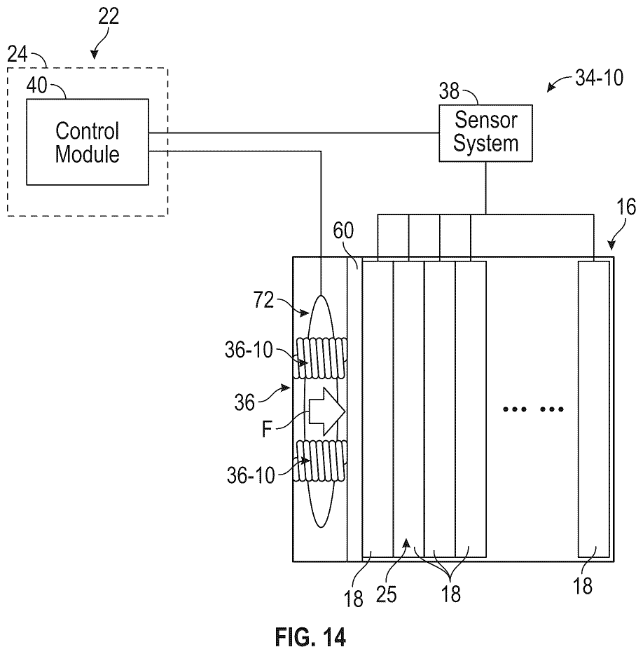

FIG. 14 illustrates another exemplary battery charging system 34-10. The battery charging system 34-10 is similar to the battery charging system 34-9 of FIG. 13 and may include one or more shape memory alloy structures 36-10 as part of the compression device 36. However, in the implementation of FIG. 12, the control module 40 is a component of the electrified vehicle 10, whereas in the implementation of FIG. 14, the control module 40 may be a component housed within the EVSE housing 24 of the EVSE system 22.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

1. A battery charging system, comprising:
a battery array;
a compression device configured to apply a compression force to the battery array during a charging event; and
a control module programmed to control the compression device such that the compression force fluctuates between a lower threshold and an upper threshold independent of a charging rate during the charging event.

2. The battery charging system as recited in claim 1, wherein the charging event includes DC fast charging.

3. The battery charging system as recited in claim 1, wherein the control module is programmed to control the compression device such that the compression force fluctuates between the lower threshold and the upper threshold while the charging rate varies during the charging event.

4. The battery charging system as recited in claim 1, wherein the lower threshold and the upper threshold are pre-set thresholds and do not change throughout an entirety of a duration of the charging event.

5. The battery charging system as recited in claim 1, wherein the control module is programmed to control the compression device such that the compression force fluctuates between the lower threshold and the upper threshold according to a predefined pattern during the charging event.

6. The battery charging system as recited in claim 5, wherein the predefined pattern is such that the control module is programmed to control the compression device such that the compression force oscillates between the lower threshold and the upper threshold.

7. The battery charging system as recited in claim 6, wherein the predefined pattern is such that the control module is programmed to control the compression device such that the compression force oscillates linearly between the lower threshold and the upper threshold.

8. The battery charging system as recited in claim 6, wherein the predefined pattern is such that wherein the control module is programmed to control the compression device such that the compression force oscillates substantially as a sine wave between the lower threshold and the upper threshold.

9. The battery charging system as recited in claim 5, wherein the predefined pattern includes controlling the compression device such that the compression force substantially alternates between the lower threshold and the upper threshold.

10. The battery charging system as recited in claim 9, wherein the predefined pattern includes controlling the compression device such that the compression force periodically, and at predefined intervals, substantially alternates between the lower threshold and the upper threshold.

11. The battery charging system as recited in claim 1, wherein the compression device includes an air bladder.

12. The battery charging system as recited in claim 1, wherein the compression device includes an air cylinder or a hydraulic cylinder.

13. The battery charging system as recited in claim 1, wherein the compression device includes a motor actuated threaded shaft rod.

14. The battery charging system as recited in claim 1, wherein the compression device includes a shape memory alloy structure.

15. The battery charging system as recited in claim 1, comprising a sensor system operably coupled to the control module and configured to monitor a charge rate during the charging event.

16. The battery charging system as recited in claim 1, wherein the control module is a component of an electrified vehicle that includes the battery charging system.

17. The battery charging system as recited in claim 1, wherein the control module is a component of an electric vehicle supply equipment (EVSE) system.

18. A method, comprising:
fluctuating a compression force applied to a battery array of a traction battery pack during a charging event, wherein the compression force fluctuates between a lower threshold and an upper threshold independent of a charging rate during the charging event.

19. The method as recited in claim 18, wherein the compression force fluctuates between the lower threshold and the upper threshold according to a predefined pattern during the charging event.

20. The method as recited in claim 19, wherein the predefined pattern is such that the compression force either (i) substantially oscillates between the lower threshold and the upper threshold or (ii) substantially alternates between the lower threshold and the upper threshold.
